(19) United States
(12) Patent Application Publication
(10) Pub. No.: US 2026/0030196 A1
(43) Pub. Date: Jan. 29, 2026

(54) SYSTEMS AND METHODS FOR TRACKER FREE RDMA CONGESTION WINDOW SUPPORT

(71) Applicant: XILINX, INC., San Jose, CA (US)

(72) Inventors: Ripduman Singh SOHAN, San Jose, CA (US); David James RIDDOCH, Cambridgeshire (GB)

(21) Appl. No.: 18/784,476

(22) Filed: Jul. 25, 2024

(51) Int. Cl. G06F 15/173; H04L 69/22

(52) U.S. Cl. CPC G06F 15/17331; H04L 69/22

(57) ABSTRACT

A method for remote direct memory access (RDMA) communication includes transmitting, from a first device to a second device via a network, a first RDMA message, storing, by the first device, a transmit byte count (tx_byte_count) of a total number of bytes transmitted in the first RDMA message, receiving, by the first device from the second device, a second RDMA message associated with the first RDMA message, the second RDMA message comprising a receive byte count (rx_byte_count) of a total number of bytes of the first RDMA message received by the second device, and determining, by the first device, a size of a congestion window on the network based on the tx_byte_count and the rx_byte_count.

### TECHNICAL FIELD

Examples of the present disclosure generally relate to remote direct memory access (RDMA) communications, and in particular to tracker free RDMA congestion window support.

### BACKGROUND

RDMA is a network protocol that allows a program or application on one computing device to directly access the memory of another computing device on a network, bypassing both devices' operating systems and CPUs. This streamlined approach can significantly reduce latency and improve performance for tasks involving bulk data transfers. One of the current congestion control algorithms for RDMA utilizes a window-like mechanism that controls the number of outstanding RDMA operations using packet trackers (e.g., per-packet size trackers). In order to determine the size of the congestion window, the congestion control algorithm requires all packets, including all requests and responses to be reliably acknowledged. However, under the current RDMA protocol, read responses are not reliably acknowledged, thus making it difficult and causing more computing resources for the congestion control algorithm to track all of the packets during RDMA operations.

Thus, solutions for a tracker free RDMA congestion window are desired.

### SUMMARY

Systems, methods, and devices are described for tracker free congestion window support for RDMA communication.

According to one aspect, a method for RDMA communication includes transmitting, from a first device to a second device via a network, a first RDMA message; storing, by the first device, a transmit byte count (tx_byte_count) of a total number of bytes transmitted in the first RDMA message; receiving, by the first device from the second device, a second RDMA message associated with the first RDMA message, the second RDMA message comprising a receive byte count (rx_byte_count) of a total number of bytes of the first RDMA message received by the second device; and determining, by the first device, a size of a congestion window on the network based on the tx_byte_count and the rx_byte_count.

According to another aspect, a system for RDMA communication includes a first device and a second device communicatively coupled to the first device via a network. The first device is configured to transmit a first RDMA message to the second device; store a transmit byte count (tx_byte_count) of a total number of bytes transmitted in the first RDMA message; receive, from the second device, a second RDMA message associated with the first RDMA message, the second RDMA message comprising a receive byte count (rx_byte_count) of a total number of bytes of the first RDMA message received by the second device; and determine a size of a congestion window on the network based on the tx_byte_count and the rx_byte_count.

According to yet another aspect, a responder device for RDMA communication with a requestor device via a network, the responder device includes circuitry configured to receive a read request from the requestor device; transmit a read response to the requestor device; store a transmit byte count (tx_byte_count) of a total number of bytes transmitted in the read response; receive an acknowledgement of the read response from the requestor device, the acknowledgement comprising a receive byte count (rx_byte_count) of a total number of bytes of the read response received by the requestor device; and determine a size of a congestion window on the network based on the tx_byte_count and the rx_byte_count.

### BRIEF DESCRIPTION OF THE DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a block diagram of a system for RDMA communications, in accordance with an example implementation of the present disclosure.

FIG. 2 illustrates a block diagram of a system for RDMA communications, in accordance with an example implementation of the present disclosure.

FIG. 3 illustrates a block diagram of a system having a computing device in communication with a server via a network, in accordance with an example implementation of the present disclosure.

FIG. 4 illustrates a flowchart diagram of a computer-implemented method for providing tracker free congestion window support in RDMA communications, in accordance with an example implementation of the present disclosure.

FIG. 5A illustrates a diagram of an RDMA read operation between a requestor and a responder via a network, in accordance with an example implementation of the present disclosure.

FIG. 5B illustrates a diagram of an RDMA write operation between a requestor and a responder via a network, in accordance with an example implementation of the present disclosure.

FIG. 6A illustrates a flowchart diagram of a computer-implemented method performed by a responder during an RDMA read operation between a requestor and the responder via a network, in accordance with an example implementation of the present disclosure.

FIG. 6B illustrates a flowchart diagram of a computer-implemented method performed by a requestor during an RDMA write operation between the requestor and a responder via a network, in accordance with an example implementation of the present disclosure.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments of the present disclosure implement various methods for both sides (e.g., requestor and responder ends) of an RDMA connection to maintain a connection-level byte fidelity congestion window that tracks a byte count of the transmitted and received bytes without requiring an explicit per-packet tracker or a read response timer.

According to an implementation, during an RDMA read operation, a requestor transmits a read request to a responder. In response to the read request, the responder transmits a read response (e.g., including read data) to the requestor. The responder stores locally a transmit byte count (tx_byte_count) indicating the number of bytes transmitted by the responder to the requestor in the read response. Upon receiving the read response, the requestor transmits an unsolicited acknowledgement of the read response (e.g., a duplicate acknowledgement (DUP_ACK)) to the responder. The acknowledgement includes a receive byte count (rx_byte_count) indicating the number of bytes of the read response received by the requestor. The responder then utilizes the tx_byte_count and the rx_byte_count to determine the size of a congestion window (e.g., the amount of data that is outstanding on the network), and provides congestion control based on the size of the congestion window.

During the RDMA read operation, in a situation that the acknowledgement (e.g., the DUP_ACK) is not received by the responder and there is no congestion window available, the responder transmits a probe packet to solicit a response or acknowledgement from the requestor. In one example, the probe packet can be effectively a retransmission of an unacknowledged packet(s). In another example, the probe packet can include a Path Minimum Transmission Unit (PMTU) size worth of data. In another example, the probe packet can have a data length/size of 0 bytes. In another example, the probe packet can be an explicit probe packet. In response to the probe packet, the requestor transmits a response or acknowledgement having the rx_byte_count to the responder, which allows the responder to synchronize its congestion window state (e.g., the byte count) with that of the requestor.

According to another implementation, during an RDMA write operation, a requestor transmits a write request to a responder. The requestor stores locally a transmit byte count (tx_byte_count) indicating the number of bytes transmitted by the requestor in the write request. The responder, in response to the write request, transmits an acknowledgement (e.g., a write acknowledgement) of the write request to the requestor. The write acknowledgement includes a receive byte count (rx_byte_count) indicating the number of bytes of the write request received by the responder. The requestor then utilizes the tx_byte_count and the rx_byte_count to determine the size of a congestion window (e.g., the amount of data that is outstanding on the network), and provides congestion control based on the size of the congestion window.

During the RDMA write operation, in a situation that the write acknowledgement is not received by the requestor and that there is no congestion window available, the requestor transmits a probe packet to solicit a response or acknowledgement from the responder. In one example, the probe packet can be effectively a retransmission of an unacknowledged packet(s). In another example, the probe packet can include a Path Minimum Transmission Unit (PMTU) size worth of data. In another example, the probe packet can have a data length/size of 0 bytes. In another example, the probe packet can be an explicit probe packet. In response to the probe packet, the responder transmits a response or acknowledgement having the rx_byte_count to the requestor, which allows the requestor to synchronize its congestion window state (e.g., the byte count) with that of the responder. If the requestor does not get an expected ACK and a subsequent ACK does not provide a valid update to synchronize the requestor's state, the requestor may re-transmit the request packets (e.g., the write request packets).

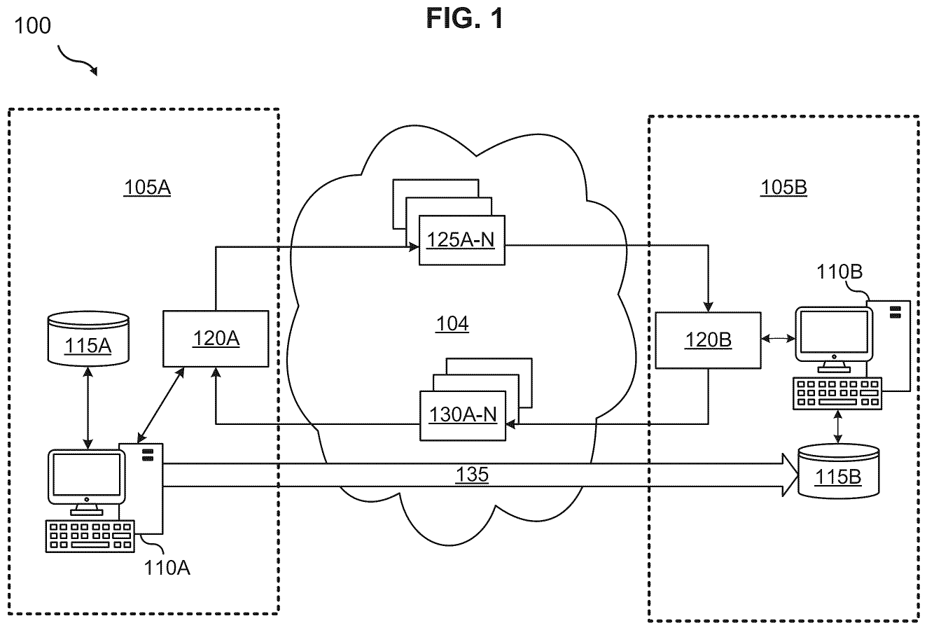

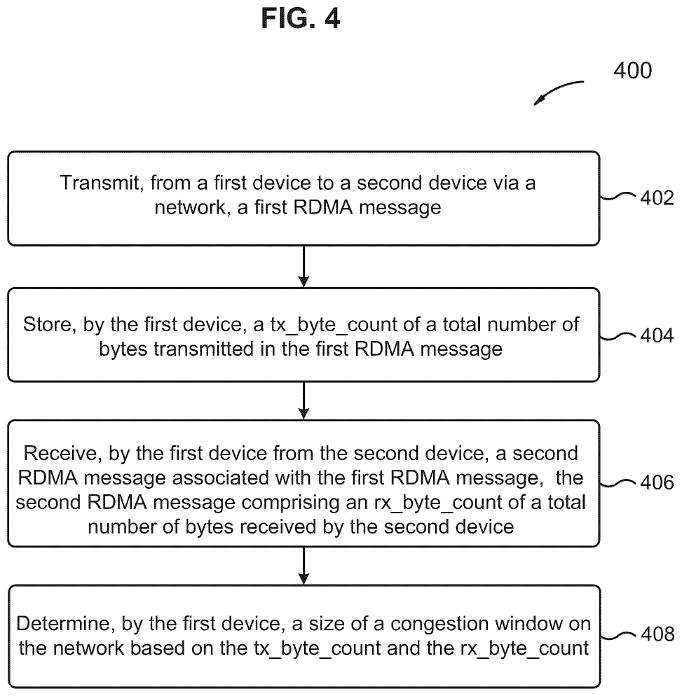

Below are provided, with reference to FIGS. 1, 2, and 3, detailed descriptions of example systems for hardware message processing. Detailed descriptions of examples of computer-implemented methods are also provided in connection with FIGS. 4, 5A, 5B, 6A, and 6B. It should be appreciated that while example implementations are provided, other implementations are possible, and implementations are not limited to operating in accordance with the examples below.

FIG. 1 is a block diagram of an example system 100 for network communications. As illustrated in this figure, the example system 100 includes a network 104 for facilitating communications between a network environment 105A and a network environment 105B.

The network 104 generally represents any medium or architecture capable of facilitating communication or data transfer. Examples of the network 104 may include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, or any other suitable network.

In some implementations, the network environment 105A is a network device that includes a connection controller 120A, an application 110A, and a memory 115A. In some implementations, the network environment 105B is a network device that includes a connection controller 120B, an application 110B, and a memory 115B. The network environment 105A can include the application 110A coupled to the memory 115A. The application 110A can request the connection controller 120A to allocate resources for communicating with the connection controller 120B of the network environment 105B for the application 110A to communicate with the memory 115B coupled to the application 110B. The connection controller 120B can transmit responses 130A-N to the connection controller 120A. After the connection controller 120A receives the responses 130A-N from the connection controller 120B, the connection controller 120A can allow the application 110A to establish RDMA communication 135 with the memory 115B.

In some implementations, the leveraging of reliably connected (RC) and unreliable datagram (UD) as standard protocols for both operations and connection management allows the RDMA communication 135 to be implemented between the network environments without hardware support. In some implementations, this means no change in RC or UD semantics are introduced in the application or middleware and no protocol level changes on the wire.

According to various implementations, all or a portion of the network environments in FIG. 1 can be implemented within a virtual environment. For example, the modules and/or data described herein can reside and/or execute within a virtual machine. As used herein, the term “virtual machine” generally refers to any operating system environment that is abstracted from computing hardware by a virtual machine manager (e.g., a hypervisor).

In some examples, all or a portion of the network environments can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of the application 110A and the application 110B in FIG. 1 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

In some examples, all or a portion of the applications in FIG. 1 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

As illustrated in FIG. 1, the system 100 can also include the memory 115A and the memory 115B. Memory generally can represent any type or form of volatile or non-volatile storage device or medium capable of storing data and/or computer-readable instructions. In one example, memory can store, load, and/or maintain the one or more controllers. Examples of memory include, without limitation, Random Access Memory (RAM), Read Only Memory (ROM), flash memory, caches, variations or combinations of one or more of the same, or any other suitable storage memory.

In some implementations, the connection controller 120A and the connection controller 120B of FIG. 1 can each be a chip, such as an integrated circuit, system on a chip (SoC), or other chip. In some cases, the chip can be a processing unit, such as a data processing unit (DPU), central processing unit (CPU), or graphics processing unit (GPU). In some implementations, the connection controller 120A and the connection controller 120B can perform one or more tasks, such as in response to instructions to be executed by the controllers. In some implementations, the connection controller 120A can initiate the RDMA communication 135. In some implementations, the connection controller 120A can maintain or disconnect the RDMA communication 135.

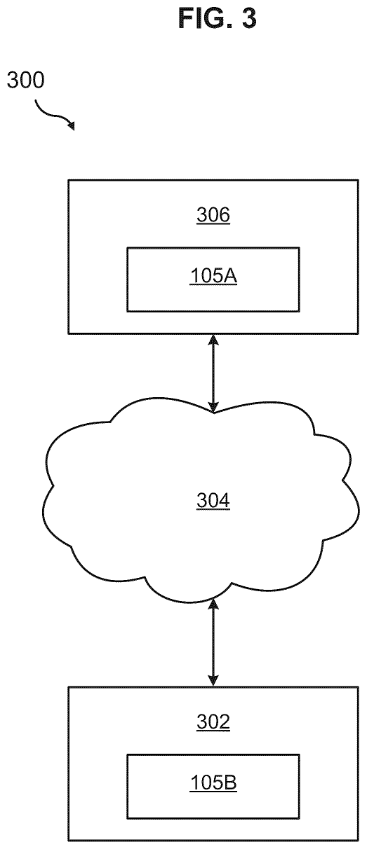

In certain implementations, the connection controller 120A and the connection controller 120B can be components of one or more computing devices, such as the devices illustrated in FIG. 3 (e.g., a computing device 302 and/or a server 306). For example, the computing device 302 can include the connection controller 120A and/or the server 306 can include the connection controller 120B. The system 300 in FIG. 3 can represent all or portions of one or more special-purpose computers configured to perform one or more tasks.

As illustrated in FIG. 1, each of the connection controllers 120A and 120B can be or include one or more circuits. While each illustrated as a single circuit, those skilled in the art will appreciate that connection controllers may each be implemented as one or more circuits. In addition, as will be discussed in further detail below, some implementations may include a sequence of circuits that includes one or more circuits interleaved with one or more circuits. In some such cases, the circuits can be configured differently from one another. For example, the connection controller 120A can generate requests 125A-N to allocate resources for the RDMA communication 135. In some implementations, the connection controller 120A can transmits responses 130A-N maintain or disconnect the RDMA communication 135.

Circuits can represent any type or form of hardware-implemented processing unit capable of interpreting and/or executing computer-readable instructions. In one example, the one or more circuits can access and/or modify one or more bits of the one or more portions of the responses 130A-N of the system 100. In one example, the one or more circuits can access and/or modify the memory of the system 100. Additionally, or alternatively, the one or more circuits can control one or more of components of the system 100. Examples of the one or more circuits include, without limitation, cores, logic units, microprocessors, microcontrollers, Field-Programmable Gate Arrays (FPGAs) that implement softcore processors, Application-Specific Integrated Circuits (ASICs), portions of one or more of the same, variations or combinations of one or more of the same, or any other suitable physical processor.

The connection controllers can be data circuits, which can facilitate the transmissions of the messages among various circuits. Examples of the data circuits include, without limitation, cores, logic units, microprocessors, microcontrollers, Field-Programmable Gate Arrays (FPGAs) that implement softcore processors, Application-Specific Integrated Circuits (ASICs), portions of one or more of the same, variations or combinations of one or more of the same, or any other suitable physical processor.

In some implementations, the requests 125A-N can include information that identifies the application 110B and the memory 115B to which the RDMA communication 135 is to be established. For example, the information can include metadata, a MAC address, and/or a destination IP that identifies the application 110B. Examples of the requests 125A-N include RDMA requests such as read, write, send, and atomic.

The responses 130A-N can include any number of commands, packets, or computer-readable instructions. Examples of the content included in the requests and responses include network data, payloads, addresses, definitions, headers, protocols, identifiers, checksum values, hashes or any other instructions received from a Network on Chip (NoC), Network Interface Controller (NIC), user logic, or fabric adapter. The messages can be configured to be transmitted among devices, data circuits, or other entities.

The RDMA communication 135 can be a direct memory access from the memory 115A of the application 110A into the memory 115B of the application 110B. For example, the RDMA communication 135 can occur without involving an operating system. In some implementations, the RDMA communication 135 can be unidirectional from the application 110A to the memory 115B of the application 110B. The connection controller 120A can allocate resources for maintaining the RDMA communication 135. The resources can be computing resources for establishing RDMA between the applications.

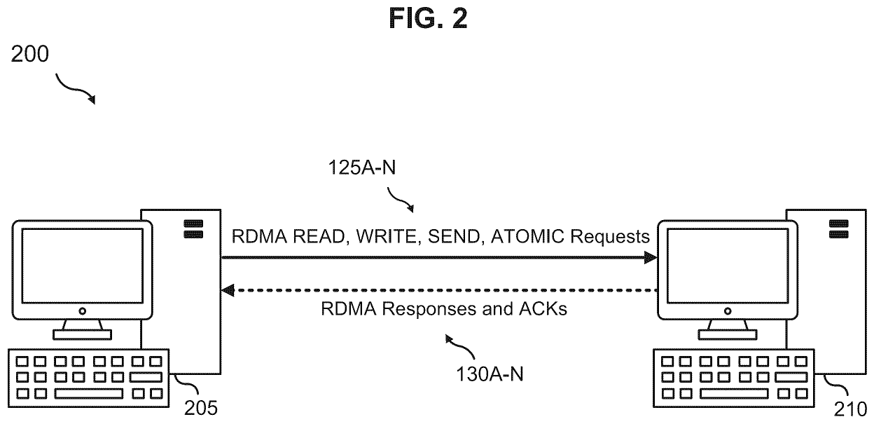

FIG. 2 illustrates an example system 200 with which some implementations can operate. Similar elements are labeled with corresponding numbers and labels from FIG. 1. Some functionality of elements shown in FIG. 2 is also described below in connection with FIGS. 4, 5A, 5B, 6A, and 6B.

The requestor 205 can initiate the requests 125A-N with the responder 210, which can respond with responses 130A-N. The requestor 205 can be similar to the network environment 105A and the connection controller 120A in FIG. 1. As shown in FIG. 2, examples of the requests 125A-N include RDMA requests such as read, write, send, and atomic. The responder 210 can be similar to the network environment 105B and the connection controller 120B in FIG. 1. As shown in FIG. 2, examples of the responses 130A-N include RDMA responses and acknowledgements (ACKs). The requestor 205 and the responder 210 can establish the RDMA communication 135 to communicate.

The system 100 in FIG. 1 and/or the system 200 in FIG. 2 can be implemented in a variety of systems. For example, all or a portion of the system 100 and/or the system 200 in FIG. 2 can represent portions of system 300 in FIG. 3. As shown in FIG. 3, the system 300 can include the computing device 302 in communication with the server 306 via the network 304. In one example, all or a portion of the functionality of system 100 can be performed by the computing device 302, the server 306, and/or any other suitable computing system. As will be described in greater detail below, one or more components from FIG. 1 can, when executed by at least one processor of the computing device 302 and/or the server 306, enable the computing device 302 and/or the server 306 for network communications.

The computing device 302 generally represents any type or form of computing device capable of reading computer-executable instructions. For example, the computing device 302 can be an integrated circuit or a network interface controller (NIC). Additional examples of the computing device 302 include, without limitation, laptops, tablets, desktops, servers, cellular phones, Personal Digital Assistants (PDAs), multimedia players, embedded systems, wearable devices (e.g., smart watches, smart glasses, etc.), smart vehicles, so-called Internet-of-Things devices (e.g., smart appliances, etc.), gaming consoles, variations or combinations of one or more of the same, or any other suitable computing device.

The server 306 generally represents any type or form of computing device that is capable of reading computer-executable instructions. For example, the server 306 can include circuits or network interfaces. In one example, the network 304 can facilitate communication between the computing device 302 and the server 306. In this example, the network 304 can facilitate communication or data transfer using wireless and/or wired connections. Additional examples of the server 306 include, without limitation, storage servers, database servers, application servers, and/or web servers configured to run certain software applications and/or provide various storage, database, and/or web services. Although illustrated as a single entity in FIG. 3, the server 306 can include and/or represent a plurality of servers that work and/or operate in conjunction with one another. In another example, the server 306 can be another computing device similar to the computing device 302.

Many other devices or subsystems can be connected to the system 100 in FIG. 1 and/or the system 200 in FIG. 2. Conversely, all of the components and devices illustrated in FIGS. 1 and 2 need not be present to practice the implementations described and/or illustrated herein. The devices and subsystems referenced above can also be interconnected in different ways from that shown in FIGS. 1 and 2. The systems 100 and/or 200 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, generally refers to any form of device, carrier, non-transitory medium, non-transitory computer-readable, or medium capable of storing or carrying computer-readable instructions. Examples of computer-readable media or non-transitory computer-readable include, without limitation, transmission-type media, such as carrier waves, and non-transitory type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other non-transitory or distribution systems.

FIG. 4 illustrates a flowchart diagram of a computer-implemented method 400 for providing tracker free congestion window support in RDMA communications, in accordance with one example implementation of the present disclosure. The method 400 shown in FIG. 4 can be performed by any suitable circuit, computer-executable code and/or computing system, including the systems 100, 200, and 300 respectively in FIGS. 1, 2, and 3, and/or variations or combinations of one or more of the same. In one example, each of the steps shown in FIG. 4 can represent a circuit or algorithm whose structure includes and/or is represented by multiple sub-steps, examples of which will be provided in greater detail below.

As illustrated in FIG. 4, step 402 includes transmitting, from a first device to a second device via a network, a first RDMA message.

In one example, during an RDMA read operation, the first RDMA message can be a read response having read data transmitted by a responder device (responder) to a requestor device (requestor), in response to a read request from the requestor device. During the read operation, as part of step 402, the connection controller 120B can, as part of the system 100 in FIG. 1, transmit a read response (e.g., one of the responses 130A-N) from the application 110B to the application 110A via the network 104. In some implementations, the read response communicates data from the application 110B to the application 110A using the RDMA communication 135. The read response can be in response to a read request from the application 110A. The read response can include the read data requested by the application 110A.

In another example, during an RDMA write operation, the first RDMA message can be a write request having write data transmitted from a requestor to a responder. During the write operation, as part of step 402, the connection controller 120A can, as part of the system 100 in FIG. 1, transmit a write request (e.g., one of the requests 125A-N) from the application 110A to the application 110B via the network 104. In some implementations, the write request communicates data from the application 110A to the application 110B using the RDMA communication 135. The write request can identify a destination to which the data is to be communicated and can further include the data to be communicated (e.g., write data to be written).

Referring back to FIG. 4, step 404 includes storing by the first device a transmit byte count (tx_byte_count) of the total number of bytes transmitted in the first RDMA message.

In an example, during an RDMA read operation, the first RDMA message can be a read response having read data transmitted by a responder to a requestor, in response to a read request from the requestor. The responder can store locally a tx_byte_count of the total number of bytes transmitted in the read response.

In another example, during an RDMA write operation, the first RDMA message can be a write request having write data transmitted from a requestor to a responder. The requestor can store locally a tx_byte_count of the total number of bytes transmitted in the write request.

It is noted that, for both read and write operations, the requestor and responder can each maintain and update their own tx_byte_count and rx_byte_count without counting duplicate packets. The requestor and responder can also synchronize their tx_byte_counts and rx_byte_counts with each other.

Referring back to FIG. 4, step 406 includes receiving, by the first device from the second device, a second RDMA message associated with the first RDMA message, the second RDMA message comprising a receive byte count (rx_byte_count) of the total number of bytes received by the second device.

In an example, during an RDMA read operation, the second RDMA message can be an acknowledgement of the read response, where the second RDMA message is transmitted from the requestor to the responder. The second RDMA message may include an rx_byte_count of the total number of bytes of the read response received by the requestor. During the read operation, as part of step 406, the connection controller 120A can, as part of the system 100 in FIG. 1, transmit an acknowledgement of the read response (e.g., one of the requests 125A-N) from the application 110A to the application 110B via the network 104. On the wire, this acknowledgement of the read response can be issued as an unsolicited duplicate acknowledgement as read responses are not reliably acknowledged under the current RDMA protocol. The acknowledgement of the read response can include an rx_byte_count of the total number of bytes of the read response received by the application 110A from the application 110B. The rx_byte_count can be contained in a transport header of the duplicate acknowledgement.

In another example, during an RDMA write operation, the second RDMA message can be an acknowledgement of the write request (e.g., a write acknowledgement (WT_ACK)), where the second RDMA message is transmitted from the responder to the requestor. The second RDMA message (e.g., the WT_ACK) can include an rx_byte_count of the total number of bytes of the write request received by the responder. During the write operation, as part of step 406, the connection controller 120B can, as part of the system 100 in FIG. 1, transmit an ACK (e.g., one of the responses 130A-N) from the application 110B to the application 110A via the network 104. The ACK can include an rx_byte_count of the total number of bytes of the write request received by the application 110B from the application 110A. The rx_byte_count can be contained in a transport header of the write acknowledgement.

Referring back to FIG. 4, step 408 includes determining, by the first device, a size of a congestion window on the network based on the tx_byte_count and the rx_byte_count.

In an example, during an RDMA read operation, the responder can determine the size of the current congestion window on the network (cwnd_inflight) based on the tx_byte_count and the rx_byte_count. During the read operation, as part of step 408, the connection controller 120B can, as part of the system 100 in FIG. 1, calculate the size of the cwnd_inflight by, for example, subtracting the rx_byte_count from the tx_byte_count.

In another example, during an RDMA write operation, the requestor can determine the size of the current congestion window on the network (cwnd_inflight) based on the tx_byte_count and the rx_byte_count. During the write operation, as part of step 408, the connection controller 120A can, as part of the system 100 in FIG. 1, calculate the size of the cwnd_inflight by, for example, subtracting the rx_byte_count from the tx_byte_count.

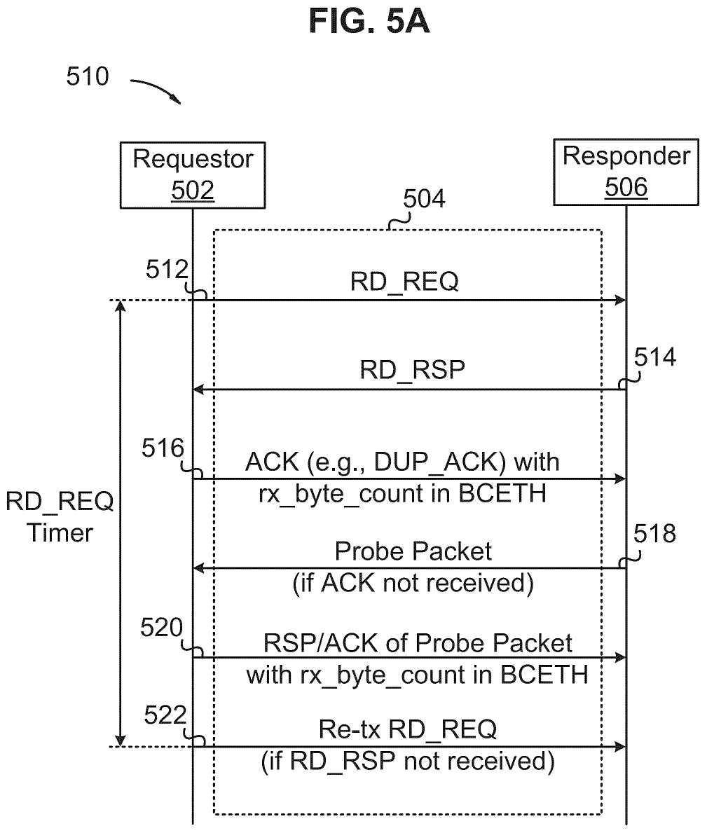

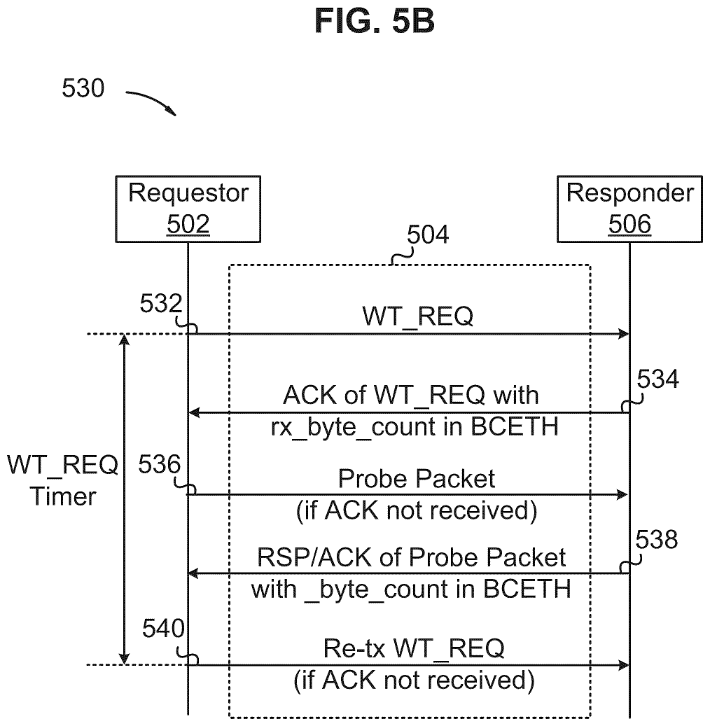

FIG. 5A illustrates a diagram of an RDMA read operation 510 between a requestor and a responder via a network, in accordance with an example implementation of the present disclosure. FIG. 5B illustrates a diagram of an RDMA write operation 530 between a requestor and a responder via a network, in accordance with an example implementation of the present disclosure.

The operations shown in FIGS. 5A and 5B can be performed by any suitable circuit, computer-executable code and/or computing system, including the systems 100, 200, and 300, respectively in FIGS. 1, 2, and 3, and/or variations or combinations of one or more of the same. In one example, each of the steps shown in FIGS. 5A and 5B can represent a circuit (or circuitry) or algorithm whose structure includes and/or is represented by multiple sub-steps, examples of which will be provided in greater detail below.

In some implementations, the requestor 502, the network 504, and the responder 506 in FIGS. 5A and 5B may substantially correspond to the network environment 105A, the network 104, and the network environment 105B, respectively, shown in FIG. 1. In some implementations, the requestor 502, the network 504, and the responder 506 in FIGS. 5A and 5B may substantially correspond to the computing device 302, the network 304, and the server 306, respectively, shown in FIG. 3.

During the RDMA read operation 510 shown in FIG. 5A, the responder 506 maintains a byte count of the transmitted and received bytes per Queue Pair (QP). The responder 506 maintains, per QP, a tx_byte_count counter. The responder 506 increases the tx_byte_count counter by the size of the packet(s) transmitted. The tx_byte_count counter is not increased if the data packet is detected as a duplicate. The responder 506 also maintains, per QP, an rx_byte_count counter. The responder 506 increases the rx_byte_count counter by the size of the packet(s) received. The rx_byte_count counter is not increased if the packet is detected as a duplicate.

As shown in FIG. 5A, in step 512, the requestor 502 transmits a read request to the responder 506. For example, the read request includes a read command and an address or location associated with requested data.

In step 514, in response to the read request, the responder 506 transmits a read response to the requestor 502. The read response includes read data as requested by the requestor 502. The responder 506 also stores locally a transmit byte count (tx_byte_count) of the total number of bytes of the read response transmitted by the responder 506.

It is noted that, under the current RDMA protocol, the requestor does not send an explicit acknowledgement of the read response to the responder. However, according to implementations of the present disclosure, as shown in FIG. 5A, after the requestor 502 receives the read response in step 514, the requestor 502 transmits an unsolicited acknowledgement of the read response (e.g., a standard unreliable duplicate acknowledgement (DUP_ACK)) back to the responder 506 in step 516, where the acknowledgement includes a receive byte count (rx_byte_count) of the total number of bytes of the read response received by the requestor 502. The rx_byte_count can be contained in a transport header, such as a byte count extended transport header (BCETH). For example, a BCETH can be carried in an ACK (e.g., a DUP_ACK), a request packet, or both to provide the latest value of rx_byte_count. The acknowledgement processing logic of the responder 506 may parse the DUP_ACK as for a write or send (WT/SND) message. In some implementations, the DUP_ACK may be an unreliable acknowledgement. It should be noted that a standard unreliable ACK may be an ACK sent from the responder to the requestor to inform the requestor a request has been received. As acknowledgements are cumulative, a subsequent ACK acknowledges everything up-to and including the PSN in the current ACK. A duplicate ACK is an ACK for a request for which an ACK has already been received. A standard unreliable duplicate acknowledgement may be a duplicate ACK sent from the responder to the requestor for a request for which an ACK has already been received. The standard unreliable duplicate ACKs are used to provide up-to-date rx_byte_count information.

During the RDMA read operation 510, the rx_byte_count received in the acknowledgement (e.g., the DUP_ACK) from the requestor 502 and the tx_byte_count stored in the responder 506 can be used by the responder 506 to determine the size of the congestion window of the network 504 (e.g., how much data is outstanding on the network 504). For example, upon receiving the rx_byte_count in the DUP_ACK, the responder 506 can calculate the size of the congestion window (cwnd_inflight), where cwnd_inflight=tx_byte_count−rx_byte_count.

During the RDMA read operation 510, in a situation that the acknowledgement (e.g., the DUP_ACK) is not received by the responder 506 and there is no congestion window available, the responder 506 transmits a probe packet, in step 518, to solicit a response or acknowledgement from the requestor 502. In one example, the probe packet can be effectively a retransmission of an unacknowledged packet(s). In another example, the probe packet may include a Path Minimum Transmission Unit (PMTU) size worth of data. In another example, the probe packet may have a data length/size of 0 bytes. In another example, the probe packet may be an explicit probe packet. In response to the probe packet, the requestor 502, in step 520, transmits a response or acknowledgement having the rx_byte_count to the responder 506, which allows the responder 506 to synchronize its congestion window state (e.g., the byte count) with that of the requestor 502.

In one implementation, steps 518 and 520 may be repeated until a valid response or acknowledgement having the rx_byte_count is received by the responder 506. If the responder 506 does not receive the DUP_ACK and a subsequent ACK does not provide a valid update to synchronize the responder 506's state, the requestor 502 may re-transmit the request packets (e.g., the read request packets).

During the RDMA read operation 510 shown in FIG. 5A, when the requestor 502 transmits the read request in step 512, it also initiates a timer (e.g., a read request timer) for tracking whether the read response is received within a timeout period. Upon expiration of the timer, in step 522, if a read response is not received by the requestor 502, the requestor 502 re-transmits the read request to the responder 506. Upon re-transmission of the read request, the cwnd_inflight on the responder 506 for the QP can be adjusted or reset.

It is noted that, for multipath read operations, the DUP_ACKs are sprayed. The responder 506 can maintain congestion window state(s) allowing it to detect and examine the relative order in which the DUP_ACKs were transmitted by the requestor 502. The responder 506 can update the congestion window state when a later transmitted DUP_ACK is received. For example, during normal operation, the rx_byte_count in the last received DUP_ACK (e.g., having the largest PSN number) should be used for calculating the size of the inflight congestion window. However, due to network delays, the DUP_ACKs received by the responder 506 on the multi-paths may be out of order. If a subsequently received DUP_ACK is older than (e.g., transmitted before) a previously processed DUP_ACK, the responder 506 can ignore the rx_byte_count in the subsequently received DUP_ACK.

In some implementations, for multipath read operations, it may be preferred to use the reflected rx_byte_count as a relative-ordering comparator to determine whether a DUP_ACK received from the multi-paths should be used to update the congestion window state.

It is noted that, if the DUP_ACK from the requestor 502 is dropped, the RD_RSP may stop making forward progress, as there is no reliability for DUP_ACKs. In other words, since the acknowledgement packets are fire-and-forget in nature, and the read responses are not acknowledged under the current RDMA protocol, the responder 506 needs the updated rx_byte_count value from the acknowledgement packets to continue to emit data onto the network. If the acknowledgement packets are dropped, the responder 506 may be unable to make forward progress. Eventually, the requestor 502 will timeout waiting for RD_RSP packets, and re-transmits the read request in step 522. When the responder 506 receives the re-transmitted read request, the responder 506 may adjust or reset the cwnd_inflight and re-transmits the read response. In another example, the requestor 502 can receive an implicit NAK after transmitting the read request. In such a case, the requestor 502 can re-transmit the read request immediately.

Referring to FIG. 5B, during the RDMA write operation 530, the requestor 502 maintains a byte count of the transmitted and received bytes per QP. For example, the requestor 502 maintains, per QP, a tx_byte_count counter. The requestor 502 increases the tx_byte_count counter by the size of the packet(s) transmitted. The tx_byte_count counter is not increased if the data packet is detected as a duplicate. The requestor 502 also maintains, per QP, an rx_byte_count counter. The requestor 502 increases the rx_byte_count counter by the size of the packet(s) received. The rx_byte_count counter is not increased if the packet is detected as a duplicate.

As shown in FIG. 5B, in step 532, the requestor 502 transmits a write request to the responder 506. For example, the write request includes a write command, data to be written, and optionally an address or location of where the write data to be stored in the responder 506. The requestor 502 stores locally a transmit byte count (tx_byte_count) of the total number of bytes of the write request transmitted by the requestor 502. After receiving the write request, the responder 506 stores the write data, for example, in a storage location indicated in the write request.

In step 534, the responder 506 transmits an acknowledgement of the write request (e.g., a WT_ACK) back to the requestor 502, where the acknowledgement includes a receive byte count (rx_byte_count) of the total number of bytes of the write request received by the responder 506. The rx_byte_count is contained in a transport header, such as a BCETH. For example, a BCETH can be carried in an ACK (e.g., a DUP_ACK), a request packet, or both to provide the latest value of rx_byte_count.

During the RDMA write operation 530, the rx_byte_count received in the acknowledgement (e.g., the WT_ACK) from the responder 506 and the tx_byte_count stored in the requestor 502 can be used by the requestor 502 to determine the size of the congestion window of the network 504 (e.g., how much data is outstanding on the network 504). For example, upon receiving the rx_byte_count in the WT_ACK, the requestor 502 can calculate the size of the congestion window (cwnd_inflight), where cwnd_inflight=tx_byte_count−rx_byte_count.

During the RDMA write operation 530, in a situation that the acknowledgement (e.g., the WT_ACK) is not received by the requestor 502 and that there is no congestion window available, the requestor 502 transmits a probe packet, in step 536, to solicit a response or acknowledgement from the responder 506. In one example, the probe packet can be effectively a retransmission of an unacknowledged packet(s). In another example, the probe packet may include a Path Minimum Transmission Unit (PMTU) size worth of data. In another example, the probe packet may have a data length/size of 0 bytes. In another example, the probe packet may be an explicit probe packet. In response to the probe packet, the responder 506, in step 538, transmits a response or acknowledgement having the rx_byte_count to the requestor 502, which allows the requestor 502 to synchronize its congestion window state (e.g., the byte count) with that of the responder 506.

In one implementation, steps 536 and 538 may be repeated until a valid response or acknowledgement having the rx_byte_count is received by the requestor 502. If the requestor 502 does not get an expected ACK and a subsequent ACK does not provide a valid update to synchronize the requestor 502's state, the requestor 502 may re-transmit the request packets (e.g., the write request packets).

During the RDMA write operation 530 shown in FIG. 5B, when the requestor 502 transmits the write request in step 532, it also initiates a timer (e.g., a write request timer) for tracking whether the ACK is received within a timeout period. Upon expiration of the timer, in step 540, if an ACK is not received by the requestor 502, the requestor 502 re-transmits the write request to the responder 506. Upon re-transmission of the write request, the cwnd_inflight on the requestor 502 for the QP can be adjusted or reset.

It is noted that, for multipath write operations, the ACKs are sprayed. The requestor 502 can maintain congestion window state(s) allowing it to detect and examine the relative order in which the ACKs were transmitted by the responder 506. The requestor 502 can update the congestion window state when a later transmitted ACK is received. For example, during normal operation, the rx_byte_count in the last received ACK (e.g., having the largest PSN number) should be used for calculating the size of the inflight congestion window. However, due to network delays, the ACKs received by the requestor 502 on the multi-paths may be out of order. If a subsequently received ACK is older than (e.g., transmitted before) a previously processed ACK, the requestor 502 can ignore the rx_byte_count in the subsequently received ACK.

In some implementations, for multipath write operations, it may be preferred to use the reflected rx_byte_count as a relative-ordering comparator to determine whether an ACK received from the multi-paths should be used to update the congestion window state.

It is noted that, for both RDMA read and write operations, the counters should be wide enough (e.g., 24b/32b) to avoid wrap-around errors caused by, for example, being unable to accurately account for amount of outstanding data on the network. The cwnd_inflight calculations can use modulo math. Thereafter, the inflight congestion window size can be used by congestion control algorithms to dispatch more traffic as needed.

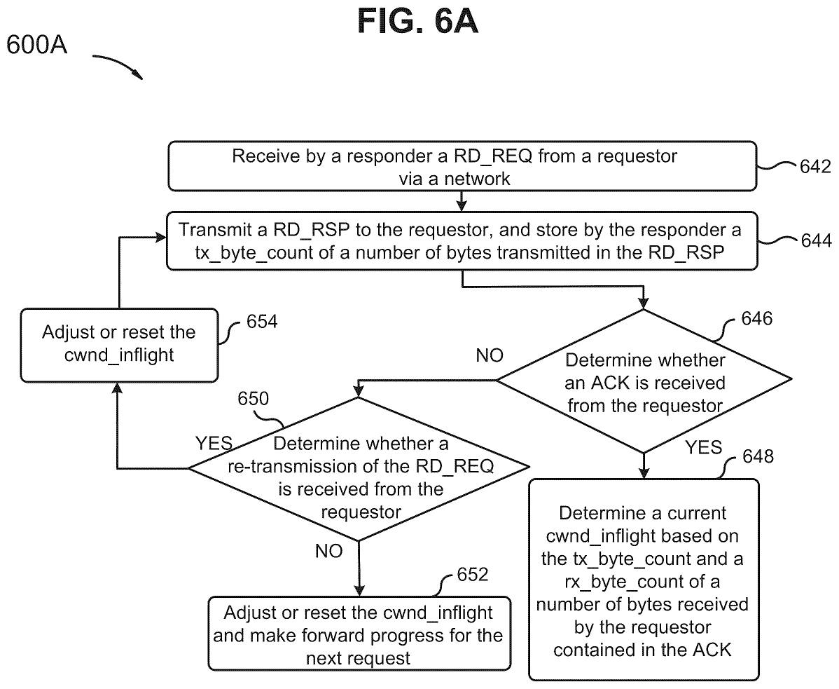

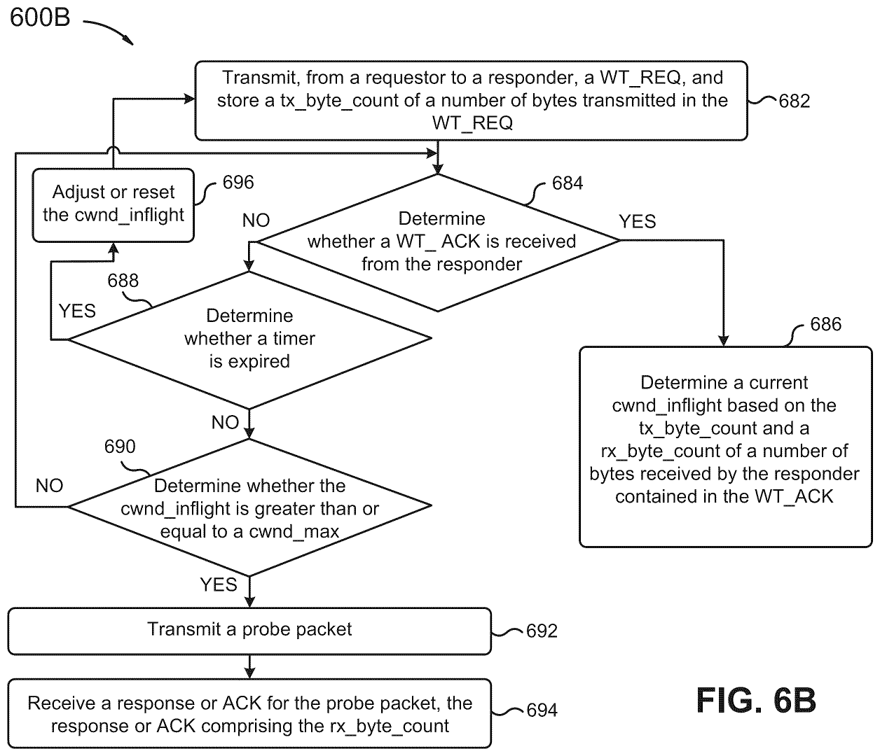

FIG. 6A illustrates a flowchart diagram of a computer-implemented method 600A performed by a responder during an RDMA read operation between a requestor and the responder via a communication channel of a network, in accordance with an example implementation of the present disclosure.

The operations shown in FIG. 6A can be performed by any suitable circuit, computer-executable code and/or computing system, including the systems 100, 200, and 300, respectively in FIGS. 1, 2, and 3, and/or variations or combinations of one or more of the same. In one example, each of the steps shown in FIG. 6A can represent a circuit or algorithm whose structure includes and/or is represented by multiple sub-steps, examples of which will be provided in greater detail below.

In some implementations, the requestor, the network, and the responder in described in FIG. 6A may substantially correspond to the network environment 105A, the network 104, and the network environment 105B, respectively, shown in FIG. 1. In some implementations, the requestor, the network, and the responder described in FIG. 6A may substantially correspond to the requestor 502, the network 504, and the responder 506, respectively, shown in FIG. 5A.

As illustrated in FIG. 6A, in step 642, the responder receives a read request (RD_REQ) from the requestor via the network. In one implementation, step 642 in FIG. 6A may substantially correspond to step 512 in FIG. 5A, the details of which are omitted for brevity.

In step 644, the responder transmits a read response (RD_RSP) to the requestor, and stores a transmit byte count (tx_byte_count) of a number of bytes transmitted in the RD_RSP. In one implementation, step 644 in FIG. 6A may substantially correspond to step 514 in FIG. 5A, the details of which are omitted for brevity.

In step 646, the responder determines whether an acknowledgement of the read response (e.g., a DUP_ACK) is received from the requestor. With reference to FIG. 5A, during the RDMA read operation 510, the requestor 502, upon receiving the read response in step 514, transmits the acknowledgement to the responder 506 in step 516 to reflect the receive byte count (rx_byte_count) of the number of bytes of the RD_RSP received by the requestor 502. However, because the acknowledgement can be dropped in the network during transmission, the responder needs to determine whether the acknowledgement is received.

Referring back to FIG. 6A, in a case that the acknowledgement is received from the requestor, in step 648, the responder determines a current inflight congestion window (cwnd_inflight) based on the tx_byte_count stored in the responder and the rx_byte_count contained in the acknowledgement (e.g., the DUP_ACK) received from the requestor.

However, the acknowledgement can be dropped in the network during transmission, which can lead to deadlocks. For example, with reference to FIG. 5A, during the read operation 510, if the read response in step 514 has maxed out the congestion window, and if the DUP_ACK from requestor 502 is dropped in the network, subsequent operations on the QP (e.g., subsequent read, write, send, and atomic operations) cannot make progress. As an example, the dropped acknowledgement can prevent further read responses from being transmitted as there is no congestion window available.

Referring back to FIG. 6A, when the responder determines that the acknowledgement is not received from the requestor during the read operation, the responder proceeds to perform steps 650 through 654 to prevent or circumvent such deadlocks. In the present implementation, the responder does not keep a local timer (e.g., a read response timer), and relies on the requestor re-issuing or re-transmitting the read request to adjust or reset the cwnd_inflight.

In step 650, in a case that the acknowledgement of the read response is not received from the requestor, the responder determines whether a re-transmission of the RD_REQ is received from the requestor.

In a case that a re-transmission of the RD_REQ is not received from the requestor, in step 652, the responder adjusts or resets the cwnd_inflight, and makes forward progress to be ready for the next request. It is noted that, in the present implementation, the responder may passively adjust or reset the cwnd_inflight or send a probe packet to solicit the latest value of the rx_byte_count from the requestor without using a read response timer. For example, in response to a need to send a subsequent read response to the requestor, the responder can either send a probe packet or determine whether it needs to adjust or reset the cwnd_inflight.

In a case that a re-transmission of the RD_REQ is received from the requestor, the responder adjusts or resets the cwnd_inflight in step 654, and re-transmits the RD_RSP to the requestor in step 644 in response to the re-transmission of the RD_REQ.

In another implementation, the responder keeps a local timer (e.g., a read response timer). When a DUP_ACK is not received in the timeout period, the responder sends a probe packet or re-transmits the read response packet(s) to solicit a response or acknowledgement having the rx_byte_count to synchronize its congestion window state (e.g., the byte count) with that of the requestor. It is noted that, in this implementation, when the read response timer expires, the responder can actively perform one of transmitting a probe packet, re-transmitting the read response packet(s), and adjusting or resetting its congesting window state with that of the requestor.

FIG. 6B illustrates a flowchart diagram of a computer-implemented method 600B performed by a requestor during an RDMA write operation between the requestor and a responder via a communication channel of a network, in accordance with an example implementation of the present disclosure.

The operations shown in FIG. 6B can be performed by any suitable circuit, computer-executable code and/or computing system, including the systems 100, 200, and 300, respectively in FIGS. 1, 2, and 3, and/or variations or combinations of one or more of the same. In one example, each of the steps shown in FIG. 6B can represent a circuit or algorithm whose structure includes and/or is represented by multiple sub-steps, examples of which will be provided in greater detail below.

In some implementations, the requestor, the network, and the responder in described in FIG. 6B may substantially correspond to the network environment 105A, the network 104, and the network environment 105B, respectively, shown in FIG. 1. In some implementations, the requestor, the network, and the responder described in FIG. 6B may substantially correspond to the requestor 502, the network 504, and the responder 506, respectively, shown in FIG. 5B.

As illustrated in FIG. 6B, in step 682, the requestor transmits a write request (WT_REQ) to a responder, and stores a transmit byte count (tx_byte_count) of a number of bytes transmitted in the WT_REQ. In one implementation, step 682 in FIG. 6B may substantially correspond to step 532 in FIG. 5B, the details of which are omitted for brevity.

In step 684, the requestor determines whether an acknowledgement of the write request (e.g., a WT_ACK) is received from the responder. With reference to FIG. 5B, during the RDMA write operation 530, the responder 506, upon receiving the WT_REQ, transmits the acknowledgement of the write request to the requestor 502 in step 534 to reflect the receive byte count (rx_byte_count) of the number of bytes of the WT_REQ received by the responder 506. However, because the acknowledgement can be dropped in the network during transmission, the requestor needs to determine whether the acknowledgement is received.

Referring back to FIG. 6B, in a case that the acknowledgement is received from the responder, in step 686, the requestor determines a current inflight congestion window (cwnd_inflight) based on the tx_byte_count stored in the requestor and the rx_byte_count contained in the WT_ACK received from the responder.

However, the acknowledgement of the write request can be dropped in the network during transmission, which can lead to deadlocks. For example, with reference to FIG. 5B, during the write operation 530, if the acknowledgement is dropped, it can lead to situations where there is insufficient capacity in the congestion window for re-transmission. For example, re-transmission of the write request cannot proceed due to lack of congestion window capacity. Also, if the write request in step 532 has maxed out the congestion window, and if the acknowledgement from the responder 506 is dropped, subsequent operations on the QP (e.g., subsequent read, write, send, atomic operations) cannot make progress.

Referring back to FIG. 6B, when the requestor determines that the acknowledgement is not received from the responder during the write operation, the requestor proceeds to perform steps 688 through 696 to prevent or circumvent such deadlocks.

In step 688, in a case that the acknowledgement is not received from the responder, the requestor determines whether a timer is expired. With reference to FIG. 5B, when the requestor 502 transmits the write request in step 532, it also initiates the write request timer.

Referring back to FIG. 6B, in a case that the timer is expired, the requestor proceeds from step 688 to step 696 to adjust or reset the cwnd_inflight before returning to step 682 to re-transmit the WT_REQ.

In a case that the timer is not expired, the flowchart proceeds from step 688 to step 690 where the requestor determines whether the cwnd_inflight is greater than or equal to a congestion window threshold (cwnd_max). It is noted that there may only be one outstanding probe packet at any point in step 690 to ensure that the cwnd_max is not exceeded by more than a probe's worth of data.

In a case that the cwnd_inflight is not greater than or equal to the cwnd_max, the flowchart returns from step 690 to step 684, where the requestor waits for the WT_ACK from the responder.

In a case that the cwnd_inflight is greater than or equal to the cwnd_max, the flowchart proceeds from step 690 to step 692 to prevent or circumvent deadlocks. In step 692, the requestor transmits a probe packet (or a probe message) having a PMTU size worth of data (or a data length/size of 0 bytes) to solicit a response or acknowledgement from the responder. The QP can exceed the congestion window threshold by up to 1 PMTU. For example, the re-transmission packet can be transmitted with BTH.AR=1.

In step 694, the requestor receives a response or acknowledgement for the probe packet, the response or acknowledgement having the total number of bytes (rx_byte_count) received by the responder. As such, the requestor can synchronize its congestion window state (e.g., the byte count) with that of the responder.

For both write request (WR_REQ) and read response (RD_RSP), a timestamp and round-trip time (RTT) estimate optimization can be used along with greedy scheduling to reset or adjust the cwnd_inflight more quickly, avoid putting data on the network, and achieve better performance. A timestamp is maintained and tied to the last WR_REQ or RD_RSP packet sent on the connection. When a WR_REQ or RD_RSP is scheduled by the TX scheduler, the timestamp is checked as follows. If the current time is less than the last transmit time plus the rtt_estimate (e.g., time_now( )<(last_tx_time+rtt_estimate)) and if the size of the congestion window is equal to a congestion window threshold (e.g., cwnd_inflight==cwnd_max), the requestor or responder does not transmit packets or adjust the congestion window size (e.g., do nothing). Otherwise, the requestor or responder resets the cwnd_inflight (e.g., cwnd_inflight==0) and transmit (or re-transmit) data packets (e.g., do_emit_packets). As such, rather than using a timer to schedule, this implementation performs a busy wait, where the requestor or responder keeps scheduling the connection but not emitting packets. This provides better performance where the WR_REQ or RD_REQ timers have long timeouts.

In another implementation, rather than waiting for the rtt_estimate to expire, the requestor or responder waits for a shorter time (e.g., every 1 μs) or varying time (e.g., exponentials increasing time) and sends a small packet (e.g., 0 byte) until a DUP_ACK or ACK is received.

The RDMA's connection-level byte-count congestion control mechanisms described in the present disclosure avoid implementing per-packet trackers for inflight bytes, and offer advantages in storage overhead and complexity compared to the packet tracker approach.

For read operations, the implementations of the present disclosure avoid the need for reliable acknowledgements in read responses, thereby reducing complexity, logic and resources required to achieve RDMA congestion control.

The methods described in the present disclosure leverage existing communication flows, operations and semantics to synchronize requestor with responder states for congestion control (e.g., to prevent or circumvent deadlocks), while requiring minimal modifications to the current RDMA protocol.

It should be understood that, although the above implementations and examples are described in the context with RDMA read and write operations, all the mechanisms described in the present disclosure can apply to other RDMA operations (such as send and atomics) as well.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A method for remote direct memory access (RDMA) communication, the method comprising:
transmitting, from a first device to a second device via a network, a first RDMA message;
storing, by the first device, a transmit byte count of a total number of bytes transmitted in the first RDMA message;
receiving, by the first device from the second device, a second RDMA message associated with the first RDMA message, the second RDMA message comprising a receive byte count of a total number of bytes of the first RDMA message received by the second device;
determining, by the first device, a size of a congestion window on the network based on the transmit byte count and the receive byte count.

2. The method of claim 1, wherein the receive byte count is contained in a transport header.

3. The method of claim 1, wherein the congestion window is a connection-level byte fidelity congestion window implemented by the first device without using a packet tracker.

4. The method of claim 1, wherein:
the first device comprises a responder device;
the second device comprises a requestor device;
the first RDMA message is a read response associated with a read request, the read response is transmitted from the responder device to the requestor device;
the second RDMA message is an acknowledgement of the read response transmitted from the requestor device to the responder device.

5. The method of claim 4, wherein the acknowledgement is a standard unreliable duplicate acknowledgement.

6. The method of claim 4, further comprising:
transmitting a probe packet from the responder device to the requestor device, in a case that the acknowledgement is not received by the responder device and that the size of the congestion window is greater than or equal to a congestion window threshold;
receiving, from the requestor device, an acknowledgement of the probe packet containing the receive byte count.

7. The method of claim 1, wherein:
the first device comprises a requestor device;
the second device comprises a responder device;
the first RDMA message is a write request transmitted from the requestor device to the responder device;
the second RDMA message is an acknowledgement of the write request transmitted from the responder device to the requestor device.

8. The method of claim 7, further comprising:
transmitting a probe packet from the requestor device to the responder device, in a case that the acknowledgement is not received by the requestor device and that the size of the congestion window is greater than or equal to a congestion window threshold;
receiving, from the responder device, an acknowledgement of the probe packet containing the receive byte count.

9. A system for remote direct memory access (RDMA) communication, the system comprising:
a first device;
a second device communicatively coupled to the first device via a network;
wherein the first device is configured to:
transmit a first RDMA message to the second device;
store a transmit byte count of a total number of bytes transmitted in the first RDMA message;
receive, from the second device, a second RDMA message associated with the first RDMA message, the second RDMA message comprising a receive byte count of a total number of bytes of the first RDMA message received by the second device;
determine a size of a congestion window on the network based on the transmit byte count and the receive byte count.

10. The system of claim 9, wherein the receive byte count is contained in a transport header.

11. The system of claim 9, wherein the congestion window is a connection-level byte fidelity congestion window implemented by the first device without using a packet tracker.

12. The system of claim 9, wherein:
the first device comprises a responder device;
the second device comprises a requestor device;
the first RDMA message is a read response associated with a read request, the read response is transmitted from the responder device to the requestor device;
the second RDMA message is an acknowledgement of the read response transmitted from the requestor device to the responder device.

13. The system of claim 12, wherein the acknowledgement is a standard unreliable duplicate acknowledgement.

14. The system of claim 12, wherein:
in a case that the acknowledgement is not received by the responder device and that the size of the congestion window is greater than or equal to a congestion window threshold, the responder device is further configured to:
transmit a probe packet to the requestor device;
receive, from the requestor device, an acknowledgement of the probe packet containing the receive byte count.

15. The system of claim 9, wherein:
the first device comprises a requestor device;
the second device comprises a responder device;
the first RDMA message is a write request transmitted from the requestor device to the responder device;
the second RDMA message is an acknowledgement of the write request transmitted from the responder device to the requestor device.

16. The system of claim 15, wherein:
in a case that the acknowledgement is not received by the requestor device and that the size of the congestion window is greater than or equal to a congestion window threshold, the requestor device is further configured to:
transmit a probe packet to the responder device;
receive, from the responder device, an acknowledgement of the probe packet containing the receive byte count.

17. A responder device for remote direct memory access (RDMA) communication with a requestor device via a network, the responder device comprising:
circuitry configured to:
receive a read request from the requestor device;
transmit a read response to the requestor device;
store a transmit byte count of a total number of bytes transmitted in the read response;
receive an acknowledgement of the read response from the requestor device, the acknowledgement comprising a receive byte count of a total number of bytes of the read response received by the requestor device;
determine a size of a congestion window on the network based on the transmit byte count and the receive byte count.

18. The responder device of claim 17, wherein the receive byte count is contained in a transport header.

19. The responder device of claim 17, wherein the congestion window is a connection-level byte fidelity congestion window implemented by the responder device without using a packet tracker.

20. The responder device of claim 17, wherein, in a case that the acknowledgement is not received by the responder device and that the size of the congestion window is greater than or equal to a congestion window threshold, the circuitry is further configured to:
transmit a probe packet to the requestor device;
receive, from the requestor device, an acknowledgement of the probe packet containing the receive byte count.
